(19) United States
(12) Patent Application Publication
(10) Pub. No.: US 2014/0300798 A1
(43) Pub. Date: Oct. 9, 2014

(54) Multi-Imager Camera for Increased Depth-of-Field Imaging

(71) Applicant: Itzhak Sapir, Irvine, CA (US)

(72) Inventor: Itzhak Sapir, Irvine, CA (US)

(21) Appl. No.: 14/243,754

(22) Filed: Apr. 2, 2014

Related U.S. Application Data
(60) Provisional application No. 61/807,847, filed on Apr. 3, 2013.

(51) Int. Cl. G02B 7/28

(52) U.S. Cl. CPC G02B 7/28
USPC 348/345

(57) ABSTRACT

A multi-imager camera having a focusing means attached to each imager in the form of a Z actuator and having an image-splitting optical assembly that splits the scene's energy to the individual imagers while maintaining the full scene coverage and while having all imagers placed in the same back-focal-distance that matches that of the camera's lens. The above camera focuses the individual imagers to different parts of the scene by individually controlling the Z actuator of each imager, and captures all images instantaneously for real-time on-board image processing or for post processing.

### CROSS-REFERENCE TO RELATED APPLICATIONS

This application claims the benefit of U.S. Provisional Patent Application No. 61/807,847, filed on Apr. 3, 2013 entitled “Multi-Imager Camera for Increased Depth-of-Field Imaging” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic imaging devices. More specifically, the invention relates to a device and method for increasing the depth of field in an image by using a novel multi-imager and optical configuration using one or more beam-splitter elements.

2. Description of the Prior Art

Prior art electronic imaging devices for increased depth-of-field include cameras such as the Lytro Light-Field camera in which a single imager is used with analyzing electro optical sensors and software to determine the ray traces of incoming light and store the information in a way that can be used in post processing to determine the desired point of focus. Prior art also include the process of “Stacking” in which multiple images of the subject are taken with different focus points to create a set of images that can be “Stacked” to generate an increased Depth-of-Filed image. Image stacking can be done manually by using a general purpose image editing software such as Adobe Photoshop. The process can also be done with the help of dedicated software tools such as CombineZ which is used to automate the stacking process.

The concept presented in the instant invention for increased Depth-of-Field imaging is not different from the stacking method as described above but the apparatus that allows this multi-image acquisition is. The major improvement over prior art is the ability to capture all the images instantaneously with each of the captured images focused to a different distance of the scene.

3. Reference Cited

US Patent Documents

| | | |
|---|---|---|
| 8,289,440 | October 2012 | Knight |
| 7,936,392 | May, 2011 | Ng |
| 7,623,726 | November, 2009 | Georgiev |

### BRIEF DESCRIPTION OF THE DRAWINGS

FIG. 1 depicts a schematic view of the imager focusing mechanism of the invention.

FIG. 2 depicts a schematic view of an exemplar embodiment optical configuration.

The invention and its various embodiments can now be better understood by turning to the following description of the preferred embodiments and related drawing figures which are presented as illustrated examples of the invention in any subsequent claims in any application claiming priority to this application.

It is expressly understood that the invention as defined by such claims may be broader than the illustrated embodiments described below.

### DETAILED DESCRIPTION OF THE INVENTION

In photography, the depth-of-field of an image is generally defined by the elements in an image that are in the foreground of, and in the background of, the focus point or image point in the scene of interest but that remain substantially in focus in the final image. This focus point element of an image is generally larger in landscape photography and smaller in macro (close-up) photography and is dependent upon the focusing distance, the focal length of the lens, and the f-number setting in addition to other variable photographic settings. Once an image of a scene is acquired, elements in the image that are not in focus cannot be later brought into focus in post-processing of the image data.

In some cases, particularly in macro-photography, the depth-of-field is too narrow from an artistic standpoint and would desirably be increased. In addition, the ability to post-process an image for focus (i.e., to decide on the focus point and desired depth-of-field of an image after acquisition) in the same way post-processing permits such as for color, sharpness, white balance and crop is highly desirable.

One prior art approach for increasing the depth-of-field of an image is taking a sequence of images with different focus points in the Z-direction (i.e., distance from the camera) but with the same composition and then later combining them into a single image. This is sometimes referred to as “image stacking” or and various software programs exist to perform such a function.

One way to create an increased depth-of-field image using the aforementioned image stacking method is by making small incremental focus adjustments using the focusing ring of the lens while the camera body is fixedly mounted on a tripod or otherwise kept fixed with respect to the photographed scene.

A disadvantage of the image stacking method is that it requires multiple images be taken at different times. In the case of a moving object or instances where the camera not kept steady, portions of the resultant captured final image will be blurred. These are sometimes referred to as “ghosts” or misaligned parts. This undesirable feature of prior art stacking methods exists even if the process of image sequence acquisition is automated (i.e., rapid automatic focus adjustments) as the plurality of images are nonetheless still acquired at different instants in time. Another deficiency found in the prior art multi-image approach is that when a user refocuses to different distances, small perspective changes necessarily occur, in turn causing a minor zooming effect from one image to the other that, in turn, reduces the overall quality of the stacked image.

The instant invention desirably uses a single exposure and a novel optical element configuration to generate all the image information needed for an increased depth-of-field image while concurrently solving the inherent perspective problem described above for refocusing to different distances. No such solution is heretofore known to be used.

The method and apparatus of the invention for creating an increased depth-of-field image in digital cameras may comprise two major elements; an instant-focusing mechanism at the imager level and a multi-imager optical element configuration that permits instantaneous capture of several images that are each respectively focused to different focus points or depths in the scene of interest.

With respect to the imager level focusing element, one or more imaging elements, such as a visible CMOS imager, are each fixedly or bonded to respective, dedicated Z-actuator; that is, an actuator that moves and positions the imager element along the optical axis of the device to define an imager-actuator assembly or element.

The Z-actuator may be a piezo-electric actuator comprised of a single layer plate or a multiple layer stack.

In an alternative embodiment, the actuator may be, but is not limited to a MEMS-based micro-actuator element such as an electrostatically driven actuator or an electromagnetically-driven form of actuator.

The function of the Z-actuator is to position the imager element at a predetermined point along the optical axis at a plane that is the focusing plane for a predetermined area in the scene (i.e., certain focusing distance). The forms of actuators described above permit very fast positioning of the imager element along the optical path of the invention prior to image acquisition.

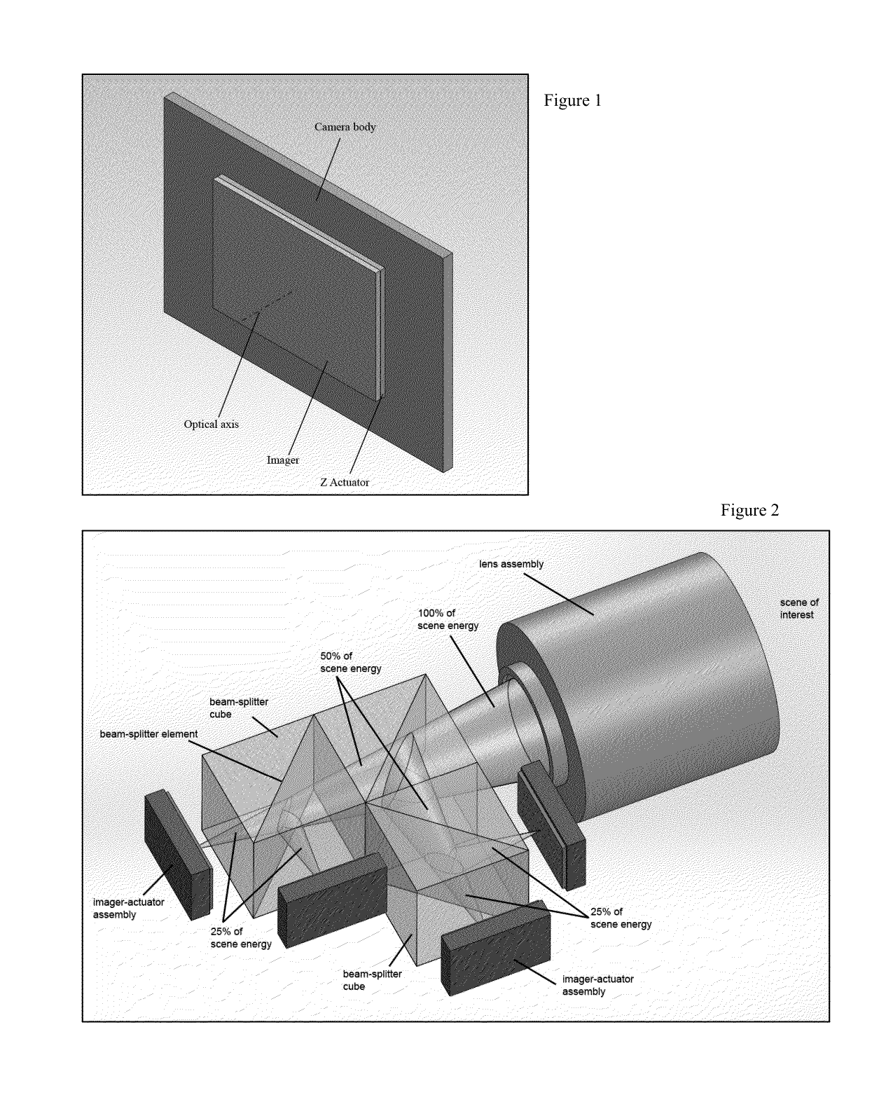

A schematic view of a preferred embodiment of the disclosed imager-actuator assembly having the focusing functionality described above is depicted in FIG. 1.

An exemplar piezo-actuator for use in the invention may comprise, for instance, a PICMA Chip Actuator as are is available from Physik Instrumente (PI) GmbH & Co. The relatively small size and power requirement of piezo-actuators (e.g., 2×2×2 mm) make them well-suited for the above application and provide sub-nanometer resolution along with sub-millisecond response times.

In the alternative, a MEMS-based actuator element configured for driving the imager focal plane, optics or both along the Z-axis may be implemented in the invention.

The actuator may also be embodied in a MEMS-fabricated micro-actuator such as in the form of an electrostatically-driven MEMS actuator as may be provided in a MEMS “comb drive” configuration of an interleaved set of plates driven by varying the voltage difference between the plate sets, or in the form of an electromagnetic actuator.

The second element of the method and device of the invention comprises a multi-sensor optical configuration comprising one or more beam-splitting elements.

A predetermined number of imager-actuator assemblies as described above are provided and configured to cooperate in combination with a predetermined number of beam-splitter cubes to create an assembly that provides a plurality of optical paths to the two or more imager-actuator elements.

An exemplar configuration comprising four imager-actuator assemblies is depicted in FIG. 2.

Other configurations having more or fewer imager-actuator elements than the illustrated embodiment are expressly contemplated and are within the scope of the invention.

The disclosed plurality of beam-splitter cubes are configured to “split” the incoming electromagnetic energy from the scene of interest (“scene energy”) at a predetermined optical energy ratio, that is to allow a portion of the image energy to pass through the beam-splitter element along a straight line and a portion to be reflected, in the illustrated embodiment, at 90 degree angle.

In the configuration of FIG. 2, each imager thus receives about 25% of the electromagnetic radiation energy received by the objective lens from the scene of interest. A key feature of the optical configuration of the invention is that each the optical paths may be provided so as to be substantially of the same length (back focal distance) as they converge to the same theoretical focal plane.

The principal of operation of the invention is as follows. After focusing to the desired image point (the point in the scene of interest from which the invention optimizes the increased depth-of-field), the invention uses suitable electronic circuitry to determine a desired or a predetermined position for each of the respective imager-actuator elements in the system to generate a defined depth-of-field coverage of the scene. The invention may be configured to consider and implement any number of standard photographic settings such as aperture, shutter speed, focusing distance or user-controlled settings for determining a desired depth-of-field stretch in order to determine the best positioning of each of the respective imagers along the optical axis.

When the scene image is captured (a single exposure), each of the respective imagers will have been exposed to partial optical energy from the scene (e.g., 25% in the embodiment of FIG. 2) while each independent imager will have acquired a different portion of the scene in substantially perfect focus.

The acquired image data from each of the plurality of imagers is then provided as an input to suitable electronic circuitry for executing image processing software and algorithms (either in-camera or post-processing) to create or assemble a final image having increased depth-of-field and with a post-determined focus point or with a non-linear focus effect.

In an alternative embodiment, an image-stacking algorithm may be provided to use one or more of the areas of the captured images that are in focus as desired by the user and at the same time, may use the energy information from all the separate images from the individual imagers to “restore” the energy level of the entire image to substantially the same level as that of the original exposure. Alternatively, the sensitivity of the individual imagers may be selectively increased or decreased (e.g., by two f-stops in the exemplar embodiment of FIG. 2) to compensate for the reduced exposure of each imager.

The instant invention beneficially solves a known prior art problem that occurs when using a lens for focusing to different distances to capture multiple images for stacking This problem is the result of minor changes to the scene coverage (a minor zooming effect) from one image to another. This effect is not present in the system of the invention in that all of the imagers the system have substantially the same coverage and each sees the same ray traces from the scene.

The instant invention permits automating the prior art method presented above in a way that can be used in existing and new digital and film cameras. The instant invention may be embodied, for instance in the digital cartridge insert inventions for film cameras disclosed in U.S. Pat. No. 5,282,040, “Apparatus for Operating a Film Camera”, to Sapir, applicant herein, U.S. Pat. No. 5,452,000, “Apparatus for Electronic Photography Using Conventional Film Camera” to Sapir, applicant herein, U.S. Pat. No. 6,147,389, “Image Sensor Package with Image Plane Reference” to Stern et al. or U.S. Pat. No. 6,393,224, “E-Film Cartridge With Sensor Avoidance Feature” to Stern et al., the entirety of each of which is incorporated herein by reference.

The instant invention further solves an inherent optical problem with using an optical lens for focusing to different distances.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

We claim:

1. An electronic camera comprised of a lens, a plurality of image sensors (imagers), an actuator attached to each of said imagers for position control along the optical axis (Z direction) and a beam-splitting optical assembly that splits the scene energy to said imagers.
At the time of image acquisition, each of said imagers is driven by each of said actuators to a different Z position to focus each of said imagers on a different part of the scene.
Using said configuration, said camera produces several images, each having a different focus point in the scene, in a single exposure.

2. An electronic camera in claim 1 in which the physical arrangement of said imagers and said beam-splitting optical assembly is such that all said imagers are positioned at the same optical back-focal-distance from said camera lens.

3. An electronic camera in claim 1 in which the physical arrangement of said imagers and said beam-splitting optical assembly is such that said imagers are positioned at different optical back-focal-distance from said camera lens. This configuration is achieved by including re-imaging optical elements within said beam-splitting optical assembly.

4. An electronic camera in claim 1 in which said Z actuator is a piezo-electric element

5. An electronic camera in claim 1 in which said Z actuator is a Micro Electro Mechanical (MEMS) device

6. An electronic camera in claim 1 in which said Z actuator is an electromagnetic device

7. An electronic camera in claim 1 in which the Z position of each of said imagers is optimized at the time of image acquisition around the selected focus point to obtain best depth-of-field result.

8. An electronic camera in claim 1 that also includes electronics and software for on-board processing (stacking) of acquired images.

9. An electronic camera comprised of a lens, a plurality of image sensors (imagers) and a beam-splitting optical assembly that splits the scene energy to said imagers.
The physical arrangement of said imagers and said beam-splitting optical assembly is such that all said imagers are fixed-mounted in a slightly shifted position from each other and from the back-focal-distance of said lens in the Z direction. The shift from the nominal back-focal-distance of each of said imagers is pre-determined to optimize the depth-of-field results in most photographic conditions.
Using said configuration, said camera produces several images, each having a different pre-determined focus point in the scene, in a single exposure.

10. An electronic camera in claim 9 that also includes electronics and software for on-board processing (stacking) of acquired images.
